(19) United States
(12) Patent Application Publication
(10) Pub. No.: US 2021/0099992 A1
(43) Pub. Date: Apr. 1, 2021

(54) RECIPROCITY BASED CSI REPORTING CONFIGURATION

(71) Applicant: Nokia Technologies Oy, Espoo (FI)

(72) Inventors: Xiaomao Mao, Palaiseau (FR); Fred Vook, Schaumburg, IL (US); Hao Liu, Shanghai (CN)

(21) Appl. No.: 16/971,210

(22) PCT Filed: Feb. 23, 2018
(86) PCT No.: PCT/CN2018/077061

§ 371 Date: Aug. 19, 2020

(51) Int. Cl. H04W 72/04; H04B 7/0417; H04B 7/0456; H04L 5/00; H04W 72/08

(52) U.S. Cl. CPC H04W 72/0413; H04B 7/0417; H04B 7/0626; H04L 5/0051; H04W 72/085; H04B 7/0486

(57) ABSTRACT

An UL channel for a UE is measured based on reference signal (s) to determine UL channel information. DL channel information is inferred based on UL-DL channel reciprocity and the determined UL channel information. Reporting is configured based on the inferred DL channel information for CSI for the UE and resource (s) are allocated for the UE to use to report the CSI. Information is signaled to the UE indicating a configuration of the reporting of CSI and the resource (s). DL reference signal (s) are transmitted toward the UE to be used for determination of the CSI. Report (s) of CSI are received on the allocated resource (s). The UE receives the configuration, determines the CSI using the configuration and the received DL reference signal (s) and fits the determined CSI into the allocated resource (s). The UE transmits the determined CSI on the allocated resource (s).

### TECHNICAL FIELD

This invention relates generally to cellular radio implementation and, more specifically, relates to channel state information (CSI) reporting and configuration for cellular radio implementation such as 2G, 3G, 4G, 5G radio access networks (RANs), Cellular IoT RAN, and/or cellular radio HW.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below, after the main part of the detailed description section.

Channel state information (CSI) is used to determine properties of a communications link. Such CSI and reporting of the same are used by both the base station (e.g., eNB or gNB) and a wireless, typically mobile, device (commonly referred to as a user equipment, UE) to adapt transmissions to current channel conditions. CSI is becoming more important as cellular radio implementation becomes more complex, which is happening due to demand for bandwidth.

In 3GPP NR MIMO discussions, type II CSI reporting uses linear combination codebooks to achieve high resolution beamforming for a single-user case and high multi-user order transmission for a multi-user case. When configured with type II CSI reporting, a UE reports several orthogonal beams together with the combining coefficients of them (e.g., amplitudes and phases), by which an accurate beamformer can be formed at gNB side to precode the DL transmission to the UE.

One problem with type II CSI reporting is the number of reported orthogonal beam changes with UE transmission scenarios, and therefore with the reported CSI payload size. It is impossible to non-causally predict and allocate resources for type II CSI reporting until the CSI is ready to be reported at UE side. Simple solutions like fixed resource allocation may result in either a waste or an insufficiency of signaling resources. This therefore compromises the system performance.

### BRIEF SUMMARY

This section is intended to include examples and is not intended to be limiting.

In an exemplary embodiment, a method comprises measuring an uplink channel for a user equipment based on one or more reference signals from the user equipment, the measuring of the uplink channel determining uplink channel information. The method includes inferring downlink channel information for the user equipment based on uplink-downlink channel reciprocity and the determined uplink channel information. The method further includes, based on the inferred downlink channel information, configuring reporting for channel state information for the user equipment and allocating one or more resources for the user equipment to use to report the channel state information. The method comprises signaling to the user equipment information indicating a configuration of the reporting of channel state information and the one or more allocated resources and transmitting one or more downlink reference signals toward the user equipment, the one or more downlink reference signals to be used by the user equipment for determination of the channel state information. The method includes receiving from the user equipment one or more reports of channel state information on the one or more allocated resources.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An exemplary apparatus includes one or more processors and one or more memories including computer program code. The one or more memories and the computer program code are configured to, with the one or more processors, cause the apparatus to perform at least the following: measuring an uplink channel for a user equipment based on one or more reference signals from the user equipment, the measuring of the uplink channel determining uplink channel information; inferring downlink channel information for the user equipment based on uplink-downlink channel reciprocity and the determined uplink channel information; based on the inferred downlink channel information, configuring reporting for channel state information for the user equipment and allocating one or more resources for the user equipment to use to report the channel state information; signaling to the user equipment information indicating a configuration of the reporting of channel state information and the one or more allocated resources; transmitting one or more downlink reference signals toward the user equipment, the one or more downlink reference signals to be used by the user equipment for determination of the channel state information; and receiving from the user equipment one or more reports of channel state information on the one or more allocated resources.

An exemplary computer program product includes a computer-readable storage medium bearing computer program code embodied therein for use with a computer. The computer program code includes: code for measuring an uplink channel for a user equipment based on one or more reference signals from the user equipment, the measuring of the uplink channel determining uplink channel information; code for inferring downlink channel information for the user equipment based on uplink-downlink channel reciprocity and the determined uplink channel information; code for based on the inferred downlink channel information, configuring reporting for channel state information for the user equipment and allocating one or more resources for the user equipment to use to report the channel state information; code for signaling to the user equipment information indicating a configuration of the reporting of channel state information and the one or more allocated resources; code for transmitting one or more downlink reference signals toward the user equipment, the one or more downlink reference signals to be used by the user equipment for determination of the channel state information; and code for receiving from the user equipment one or more reports of channel state information on the one or more allocated resources.

In an additional exemplary embodiment, an apparatus comprises means for performing: measuring an uplink channel for a user equipment based on one or more reference signals from the user equipment, the measuring of the uplink channel determining uplink channel information; inferring downlink channel information for the user equipment based on uplink-downlink channel reciprocity and the determined uplink channel information; based on the inferred downlink channel information, configuring reporting for channel state information for the user equipment and allocating one or more resources for the user equipment to use to report the channel state information; signaling to the user equipment information indicating a configuration of the reporting of channel state information and the one or more allocated resources; transmitting one or more downlink reference signals toward the user equipment, the one or more downlink reference signals to be used by the user equipment for determination of the channel state information; and receiving from the user equipment one or more reports of channel state information on the one or more allocated resources.

Another exemplary embodiment is a method comprising transmitting one or more reference signals toward a base station. The method comprises receiving, based in part on the transmitted one or more reference signals and from the base station, signaling indicating a configuration of reporting of channel state information to be used by the user equipment and one or more allocated resources to be used for the reporting. The method further comprises receiving one or more downlink reference signals from the base station. The method additionally comprises determining the channel state information using the configuration of reporting of channel state information and the received one or more downlink reference signals and fitting the determined channel state information into the one or more allocated resources. The method also comprises transmitting toward the base station one or more reports of the channel state information on the one or more allocated resources.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An exemplary apparatus includes one or more processors and one or more memories including computer program code. The one or more memories and the computer program code are configured to, with the one or more processors, cause the apparatus to perform at least the following: transmitting one or more reference signals toward a base station; receiving, based in part on the transmitted one or more reference signals and from the base station, signaling indicating a configuration of reporting of channel state information to be used by the user equipment and one or more allocated resources to be used for the reporting; receiving one or more downlink reference signals from the base station; determining the channel state information using the configuration of reporting of channel state information and the received one or more downlink reference signals; fitting the determined channel state information into the one or more allocated resources; and transmitting toward the base station one or more reports of the channel state information on the one or more allocated resources.

An exemplary computer program product includes a computer-readable storage medium bearing computer program code embodied therein for use with a computer. The computer program code includes: code for transmitting one or more reference signals toward a base station; code for receiving, based in part on the transmitted one or more reference signals and from the base station, signaling indicating a configuration of reporting of channel state information to be used by the user equipment and one or more allocated resources to be used for the reporting; code for receiving one or more downlink reference signals from the base station; code for determining the channel state information using the configuration of reporting of channel state information and the received one or more downlink reference signals; code for fitting the determined channel state information into the one or more allocated resources; and code for transmitting toward the base station one or more reports of the channel state information on the one or more allocated resources.

A further exemplary embodiment is an apparatus comprising means for performing: transmitting one or more reference signals toward a base station; receiving, based in part on the transmitted one or more reference signals and from the base station, signaling indicating a configuration of reporting of channel state information to be used by the user equipment and one or more allocated resources to be used for the reporting; receiving one or more downlink reference signals from the base station; determining the channel state information using the configuration of reporting of channel state information and the received one or more downlink reference signals; fitting the determined channel state information into the one or more allocated resources; and transmitting toward the base station one or more reports of the channel state information on the one or more allocated resources.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 is a table that might be used for example payload calculation for WB+SB amplitude, for (N₁, N₂)=(4, 4), ┌log₂(O₁, O₂)┐=4, Z=3 (8-PSK phase), for K leading coefficients;

FIGS. 3 and 4 are logic flow diagrams performed by a base station or a UE, respectively, for reciprocity based CSI reporting configuration, and illustrate the operation of an exemplary method or methods, a result of execution of computer program instructions embodied on a computer readable memory, functions performed by logic implemented in hardware, and/or interconnected means for performing functions in accordance with exemplary embodiments; and

FIG. 5 illustrates values of (N_{1,2}) and (O₁,O₂) that are supported for beam selection and parameters for a Type II single-panel (SP) codebook.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for reciprocity based CSI reporting configuration. Additional description of these techniques is presented after a system into which the exemplary embodiments may be used is described.

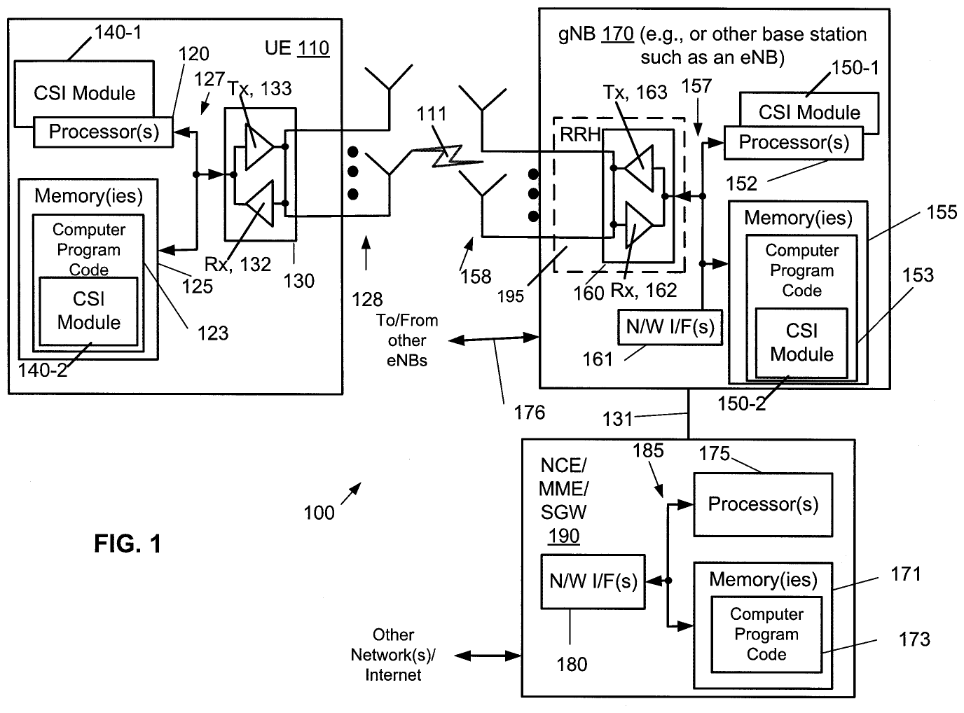

Turning to FIG. 1, this figure shows a block diagram of one possible and non-limiting exemplary system in which the exemplary embodiments may be practiced. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a CSI module 140, comprising one of or both parts 140-1 and/or 140-2, which may be implemented in a number of ways. The CSI module 140 may be implemented in circuitry as CSI module 140-1, such as being implemented as part of the one or more processors 120. The CSI module 140-1 may be implemented also as an integrated circuit or through other circuitry such as a programmable gate array. In another example, the CSI module 140 may be implemented as CSI module 140-2, which is implemented as computer program code 123 and is executed by the circuitry of the one or more processors 120. For instance, the one or more memories 125 and the computer program code 123 may be configured to, with the one or more processors 120, cause the user equipment 110 to perform one or more of the operations as described herein. The UE 110 communicates with gNB 170 via a wireless link 111.

The gNB 170 is a base station (e.g., for 5G/NR) that provides access by wireless devices such as the UE 110 to the wireless network 100. The gNB 170 170 is one example of a suitable base station, but the base station may also be an eNB (for LTE) or other base stations for, e.g., 2G or 3G. The gNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The gNB 170 includes a CSI module 150, comprising one of or both parts 150-1 and/or 150-2, which may be implemented in a number of ways. The CSI module 150 may be implemented in circuitry as CSI module 150-1, such as being implemented as part of the one or more processors 152. The CSI module 150-1 may be implemented also as an integrated circuit or through other circuitry such as a programmable gate array. In another example, the CSI module 150 may be implemented as CSI module 150-2, which is implemented as computer program code 153 and is executed by circuitry of the one or more processors 152. For instance, the one or more memories 155 and the computer program code 153 are configured to, with the one or more processors 152, cause the gNB 170 to perform one or more of the operations as described herein. The one or more network interfaces 161 communicate over a network such as via the links 176 and 131. Two or more gNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the gNB 170 being physically in a different location from the RRH, and the one or more buses 157 could be implemented in part as fiber optic cable to connect the other elements of the gNB 170 to the RRH 195.

The wireless network 100 may include a network control element (NCE) 190 that may include MME (Mobility Management Entity)/SGW (Serving Gateway) functionality, and which provides connectivity with a further network, such as a telephone network and/or a data communications network (e.g., the Internet). The gNB 170 is coupled via a link 131 to the NCE 190. The link 131 may be implemented as, e.g., an Si interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, gNB 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the exemplary embodiments of this invention, the exemplary embodiments will now be described with greater specificity.

As previously stated, one problem with one type of CSI reporting called type II CSI reporting is the number of reported orthogonal beam changes with UE transmission scenarios, and therefore with the reported CSI payload size. In more detail, Linear Combination Codebook (LCC) is adopted in NR for Type II CSI reporting and also in R14 LTE as the advanced CSI codebook. When LCC is used, a UE reports the indexes of a number of predefined DFT beams, together with which the combining coefficients of them. Using the reported DFT beams and the combining coefficients, the gNB reconstructs the channel vector of the UE and based on the channel vector applies the MIMO transmission in DL. The type II CSI reporting is a version of linear combination codebook (LCC) reporting. Additional detail regarding type II CSI reporting is outlined in the section entitled “Type II single-panel (SP) codebook” in Samsung, et al., “WF on Type I and II CSI codebooks”, R1-1709232, 3GPP TSG-RAN WG1 #89, Hangzhou, China, 15-19 May 2017.

Omission rules are defined in 3GPP NR R15 MIMO discussion for type II CSI reporting. See, e.g., 3GPP TS 38.214 in clause 5.2.3, Table 5.2.3-1 (e.g., 3GPP TS 38.214 V15.0.0 (2017-12)). When pre-allocated/assigned signaling resources (e.g., CSI report container) are insufficient to carry a type II CSI report, component carrier index-based priority rule and frequency domain decimation will be applied, and the CSI report will be partially dropped to fit the container. The motivation of type II CSI reporting is for high resolution beamforming and high order multi-user transmission, and partial omission of CSI report will significantly reduce the system performance of type II CSI reporting.

To address these issues, we provide in an exemplary embodiment a method to predict and allocate a signaling resource for type II CSI reporting by exploring channel reciprocity between UL and DL in, e.g., a NR MIMO system. In UL, the gNB 170 may estimate the orthogonal beam number as well as rank of the UL channel of the UE 110, and use the information to configure the type II CSI reporting for DL channel estimation and accordingly allocate the signaling resource for the UE 110. The UE 110 will estimate type II CSI based on the configuration and fit the report into the allocated signaling resource. Because partial omission of a CSI report or a waste of signaling resource is or are avoided, improved signaling overhead efficiency is achieved while type II CSI reporting performance is guaranteed in this way.

For ease of reference, the rest of this document is subdivided by headings. The headings are used to introduce the section and are not meant to be limiting.

### A. Type II CSI Reporting

An overview for a Type II single-panel (SP) codebook and associated reporting follows. The NR supports Type II Cat 1 CSI for rank 1 and 2. PMI is used for spatial channel information feedback. The PMI codebook assumes the following precoder structure:

For rank 1:

$$W = [ \begin{matrix}{\tilde{w}}_{0 , 0} \\ {\tilde{w}}_{1 , 0}\end{matrix} ] = {W}_{1} {W}_{2} ,$$

W is normalized to 1; and

For rank 2:

$$W = [ \begin{matrix}{\tilde{w}}_{0 , 0} & {\tilde{w}}_{0 , 1} \\ {\tilde{w}}_{1 , 0} & {\tilde{w}}_{1 , 1}\end{matrix} ] = {W}_{1} {W}_{2} ,$$

columns of W are normalized to

$$\frac{1}{\sqrt{2}} .$$

A weighted combination of L beams) is as follows:

$${\tilde{w}}_{r , l} = {\sum }_{i = 0}^{L - 1} {b}_{{k}_{1}^{( i )} {k}_{2}^{( i )}} \cdot {p}_{r , l , i}^{( WB )} \cdot {p}_{r , l , i}^{( SB )} \cdot {c}_{r , l , i} ,$$

where:

The value of L is configurable: L∈{2,3,4};

bₖ_{₁}_{,k}_{₂} is an oversampled 2D DFT beam;

r=0,1 (polarization), l=0,1 (layer);

p_{r,l,i}^{(WB)} is a wideband (WB) beam amplitude scaling factor for beam i and on polarization r and layer l;

p_{r,l,i}^{(SB)} is a subband (SB) beam amplitude scaling factor for beam i and on polarization r and layer l; and

c_{r,l,i} is a beam combining coefficient (phase) for beam i and on polarization r and layer l, and is configurable between QPSK (2 bits) and 8PSK (3 bits).

There is a configurable amplitude scaling mode between WB+SB (with unequal bit allocation) and WB-only.

Regarding beam selection and parameters for a Type II SP codebook, beam selection is wideband only. There is an unconstrained beam selection from orthogonal basis as follows:

k₁⁽ⁱ⁾=O₁·n₁⁽ⁱ⁾+q₁,i=0, . . . ,L−1;

k₂⁽ⁱ⁾=O₂·n₂⁽ⁱ⁾+q₂,i=0, . . . ,L−1;

q₁=0, . . . ,O₁−1,q₂=0, . . . ,O₂−1(rotation factors); and

n₁⁽ⁱ⁾=0, . . . ,N₁−1,n₂⁽ⁱ⁾=0, . . . ,N₂−1(orthogonal beam indices).

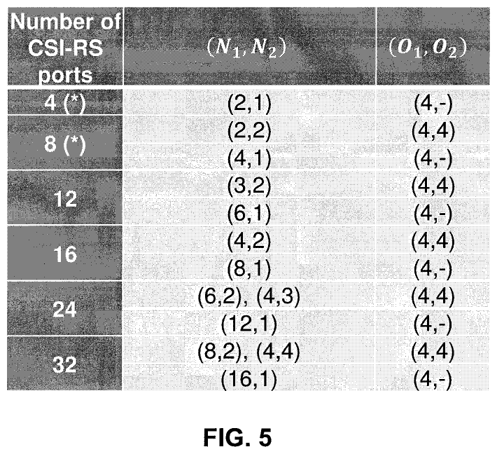

FIG. 5 illustrates values of (N_{1,2}) and (O₁,O₂) that are supported. The (*) indicates as following: for 4-port, L=2 (L=3, 4 is not supported); and for 8-port, L=4.

Regarding amplitude and combining coefficients for a Type II SP codebook, amplitude scaling and phase for combining coefficients are described below.

Amplitude scaling is independently selected for each beam, polarization, and layer. The UE is configured to report wideband amplitude with or without subband amplitude:

Wideband p_{r,l,i}^{(WB)}+Subband p_{r,l,i}^{(SB)}: Both (p_{0,0,i}^{(WB)}≠p_{0,1,i}^{(WB)}≠p_{1,0,i}^{(WB)}≠p_{1,1,i}^{(WB)} and p_{0,0,i}^{(SB)}≠p_{0,1,i}^{(SB)}≠p_{1,0,i}^{(SB)}≠p_{1,1,i}^{(SB)}) are possible.

Wideband p_{r,l,i}^{(WB)} only: (p_{0,0,i}^{(WB)}≠p_{0,1,i}^{(WB)}≠p_{1,0,i}^{(WB)}≠p_{1,1,i}^{(WB)} is possible.

Wideband amplitude value set (3 bits) is as follows: {1, \sqrt{0.5}, \sqrt{0.25}, \sqrt{0.125}, \sqrt{0.0625}, \sqrt{0.0313}, \sqrt{0.0156}, 0}.

PMI payload can vary depending on whether an amplitude is zero or not. Most details of payload have been finalized. What remains for determination is, when payload is less than the allocated resource, what is to be done with the spare resource that will not be used for the payload. This has, not been finalized.

Subband amplitude value set (1 bit) is as follows: {1, \sqrt{0.5}}.

For phase for combining coefficients, this is independently selected for each beam, polarization, and layer and is for subband only.

The phase value set is either

$$\{ {e}^{j \frac{π n}{2}} ,$$

n=0,1,2,3} (2 bits) or {

$${e}^{j \frac{π n}{4}} ,$$

n=0, 1, . . . , 7} (3 bits).

Regarding bit allocation for amplitude scaling and phase for a Type II SP codebook, (WB amplitude, SB amplitude, SB phase) are quantized and reported in (X,Y,Z) bits, respectively, as follows. It should be noted that, for each layer, for the leading (strongest) coefficient out of 2L coefficients, (X, Y, Z)=(0,0,0). The leading (strongest) coefficient=1.

For WB+SB amplitude, the following apply.

(X, Y)=(3,1) and Z∈{2,3} for the first (K−1) leading (strongest) coefficients out of (2L−1) coefficients, and (X,Y,Z)=(3,0,2) for the remaining (2L−K) coefficients. For L=2, 3, and 4, the corresponding value of K is 4 (=2L), 4, and 6, respectively.

The following coefficient index information is reported in a WB manner:

1) The index of strongest coefficient out of 2L coefficients (per layer); and

2) The (K−1) leading coefficients are determined implicitly from reported (2L−1) WB amplitude coefficients per layer without additional signaling.

For WB-only amplitude, i.e. Y=0, the following apply.

(X, Y)=(3, 0) and Z∈{2,3}.

The index of the strongest coefficient out of 2L coefficients is reported per layer in a WB manner.

To configure type II CSI reporting with a certain antenna port layout and a beam oversampling rate, the parameters below are typically signaled to the UE 110 by the gNB 170:

L: number of the reported orthogonal beams;

WB or WB+SB: coefficients amplitude reporting mode;

QPSK or 8PSK: coefficients phase reporting quantization; and/or

K: bit allocation parameter, where the first K leading coefficients are reported with higher resolution.

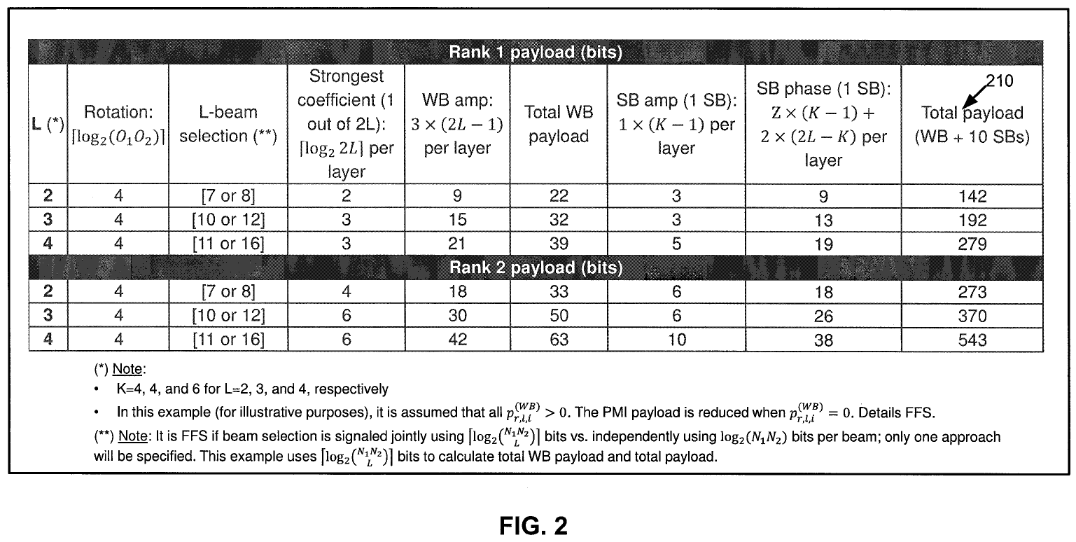

All these parameters may impact the report payload size. One exemplary table for (N₁, N₂)=(4, 4), ┌log₂(Oᵣ, O₂)┐=4, and Z=3 (8-PSK phase), for K leading coefficients, is shown in FIG. 2. This figure is a modified version of a table from Samsung, et al., “WF on Type I and II CSI codebooks”, R1-1709232, 3GPP TSG-RAN WG1 #89, Hangzhou, China, 15-19 May 2017. The variable Z indicates a number of bits used to quantize the SB phase, in this case 3 bits used for 8-PSK phase.

It can be seen that besides the parameters listed above, to configure type II CSI reporting, because the combining coefficients of orthogonal beams are reported separately for each layer, channel rank information also impacts the CSI report payload size. See, e.g., the total payload 210, which varies based on the information in the table.

### B. Parameter and Rank Estimation at gNB 170

To predict type II CSI report payload size, the gNB 170 first measures UE's UL channel based on UL reference signal(s) (e.g., SRS), and then using the UL channel information to infer the DL channel based on UL-DL channel reciprocity. With the DL channel information, the gNB 170 configures the type II CSI reporting (e.g., L, K, WB or WB+SB for amplitude report, QPSK or 8PSK for phase quantization), and, together with the channel rank information, configures the CSI report payload size (i.e., UL resource allocation for CSI report). While details of implementation for inference of DL channel based on UL-DL reciprocity is up to gNB design, one exemplary method using Eigen decomposition together with thresholding is described below.

i) Rank Estimation

Assume that channel vector at PRB i estimated from UL SRS is denoted as hᵢ, then the spatial channel covariance matrix at current subframe n is computed by averaging over all used PRBs:

R(n)=Σᵢ·hᵢ·hᵢ^{H},

where R(n) is the spatial channel covariance matrix at current subframe n, hᵢ, is the i-th channel matrix h, hᵢ^{H} is the Hermitian transpose (also called the conjugate transpose) of the i-th channel matrix h, and the dot indicates matrix multiplication.

Performing Eigen decomposition of the spatial channel covariance matrix R(n), we have the following:

R(n)=UΛU^{N},

where U is the square matrix whose j^{th} column is the eigenvector qⱼ of R(n) and Λ is the diagonal matrix whose diagonal elements are the corresponding Eigenvalues, i.e., Λⱼⱼ=λⱼ.

Usually the Eigenvalues are sorted in a decreasing order λ₁≥λ₂≥ . . . , and one way to estimate the rank is setting a threshold t for eigenvalues and if the j^{th} eigenvalue is greater than the threshold, the j^{th} layer is added to the transmission:

rank [symbol] max j,λ₃>t.

In NR R15, type II CSI reporting supports a maximum rank 2 transmission, so another simple way to determine transmission rank is to measure the difference between the first two Eigenvalues,

λ₀−λ₁>t.

If the difference is greater than threshold t, rank one (one layer) transmission will be used (i.e., the rank is one), otherwise rank two transmission (two layers transmission) will be used (i.e., the rank is two).

ii) Parameter L

In type II CSI reporting, orthogonal beams are reported in a wideband manner, where channel vectors from different polarizations and different layers can be combined based on Max Ratio Combining (MRC), and then the combined channel vector is used to derive the orthogonal beams. On the other hand, one simple way to derive the parameter L is to take out the channel vector associated with the dominant polarization and the dominant layer, and then based on this channel vector to derive the number of orthogonal beams. The rationale is usually that the collocated orthogonal polarized antennas are assumed to be independent identical distributed (i.i.d). That is to say, channel vectors from different polarizations experience very similar channels in a long-term, wideband manner.

Assume that channel at PRB i from one polarization is denoted as hᵢ⁺, then the spatial channel covariance matrix averaging over all PRBs is the following:

R⁺(n)=Σᵢhᵢ⁺·(hᵢ⁺)^{H}.

Performing Eigen decomposition of the spatial channel covariance and dropping the polarization notation, we arrive at the following:

R(n)=UΛU^{H},

where U is the square matrix whose j^{th} column is the eigenvector qⱼ of R(n) and A is the diagonal matrix whose diagonal elements are the corresponding Eigenvalues, i.e. Λⱼⱼ=λⱼ. Denoting the dominant Eigenvector as U*, one way to estimate the parameter L is to compute its correlation with candidate orthogonal beams, if the correlation with one candidate beam b is greater than a predefined threshold γ, then beam b is counted in the reported beams:

corr(U*,b)>γ.

This is because in NR R15 type II CSI reporting, where L={2, 3, 4}, the threshold value γ can be adjusted based on simulations, so parameter L can be properly selected within its range.

iii) Parameter K and Quantization Bit Width

The (WB amplitude, SB amplitude, SB phase) are quantized and reported in (X,Y,Z) bits, respectively. This is described in more detail in Samsung, et al., “WF on Type I and II CSI codebooks”, R1-1709232, 3GPP TSG-RAN WG1 #89, Hangzhou, China, 15-19 May 2017.

The amplitude of combining coefficients can be reported either in a WB or WB+SB manner (with their according quantization bit width). To determine if SB report is needed, the channel frequency selectivity of a UE may be measured. Same principle applies to the determination of parameter K, which is the bit allocation parameter, where the first K leading coefficients are reported with higher resolution. One extreme exemplary case is when the UE channel is perfectly flat, no SB reporting either for amplitude or phase is needed, thus K can be set as 1 (one) and only the wideband combining coefficient will be reported.

For most of the NLoS scenarios, the UE channel is quite frequency selective, and SB reporting can enhance the system performance by providing additional channel information. In this case, parameter K can be used to adjust the overhead by allowing more bits for those “dominant” beams (e.g., beams associated with higher-valued Eigen vectors) and fewer bits for the “less important” beams (e.g., beams associated with lower-valued Eigen vectors, relative to the higher-valued Eigen vectors).

To measure UE channel frequency selectivity, we can compute the spatial channel covariance for each PRB i, as follows:

Rᵢ(n)=hᵢ·hᵢ^{H}.

Then, take Eigen decomposition, and acquire the dominant Eigenvector Uᵢ* for PRB i, as follows:

Rᵢ(n)=UᵢΛᵢUᵢ^{H}.

Measure the average correlation between dominant Eigen vector Uᵢ* for PRB i and the wideband dominant Eigen vector Uᵢ*, and compare the average correlation to a predefined threshold η as follows:

Σᵢ corr(Uᵢ*,U*)>η.

It can be determined that if the UE channel is frequency flat enough for WB amplitude report only or SB amplitude reporting is necessary. That is, correlation is a metric for measuring “similarity” between vectors, and a high correlation between Eigenvectors in a wide frequency range indicates high “similarity”. Thus, narrow-band reporting can be omitted, since the wide-band eigenvector is sufficiently representative for the whole frequency range. The opposite is also true: a low correlation indicates SB phase reporting should also be used.

In the same way, we can also determine if more bits are needed for SB amplitude reporting. In other words, if the correlation is lower, then more bits are needed for SB amplitude reporting. That is, a bad/lower correlation means more bits are needed for SB amplitude reporting, but a good/higher correlation means fewer bits are needed for SB amplitude reporting. The WB amplitude report and the SB amplitude reporting (if used) and the SB phase reporting (if used) affect the amount of quantization bit width.

It should be noted for SB phase, the quantization bit width is dependent on the resolution that will be used to depict the phase of the coefficients. That is, for amplitude reporting we can say that because once SB reporting is needed, the bit width of the amplitude reporting is adjusted, which may be a result of the correlation comparison described above. But for phase reporting, as this is always SB, the bit width reflects the resolution of phase reporting, and does not reflect the channel correlation comparison.

### C. Other Considerations and Additional Examples

Several factors may also be considered on configuring the type II CSI reporting, such as UE speed and system capacity. For example, when UE speed is high and CSI reporting resource allocation is approaching the system capacity upper bound, fewer beams with only WB amplitude reporting can be configured to lower the report overhead while maintaining an acceptable performance for type II CSI reporting.

The exemplary methods proposed above can also applied to the following cases:

a) For beamformed CSI codebook in NR R15, which adopts the type II CSI reporting rationale, parameter L can be similarly determined as aforementioned.

b) For an FDD system, the reciprocity is less preferable than in a TDD system. However, as the proposed exemplary methods rely on the long-term wideband averaged spatial channel information, these methods also work in an FDD system.

c) For UE transmit antenna switching, UE transmit antenna switching can be enabled to guarantee that a complete UL channel can be acquired at the gNB side. When only partial UL channel is available, for example only one transmit antenna associated with one polarization is available in UL (e.g., single UE transmit antenna case), the above described methods also work.

d) CBSR (codebook subset restriction) can be applied together with the proposed exemplary methods to ensure correct UE CSI reporting behavior. For example, when UE dominant Eigenvector U* correlates with several beams and the gNB 170 sets L=2, CBSR can be enabled and properly set to prevent those less preferable orthogonal beams from being reported.

In an exemplary embodiment, a new parameter is introduced for use, e.g., in specifications. Specifically, the parameter L, the number of selected beams, should be signaled by the base station to guide the UE on CSI report content preparing. The signaling of parameter L can be, e.g., implemented by either MAC-CE or DCI based on a trade-off between dynamicity or overhead control. Generally speaking, for control signaling, RRC<MAC-CE<DCI in dynamicity.

Additionally, modification of existing parameters may be used to implement exemplary embodiments herein. Specifically, in NR R15, parameters regarding the Type II CSI reporting, including WB or WB+SB amplitude reporting, quantization bit-width for phase reporting and the parameter K, are RRC configured. In order to increase dynamicity, these parameters can be modified to be signaled by MAC-CE or DCI. In this way, Type II CSI reporting configuration may follow UE channel variation and achieve a better efficiency of signaling resource usage.

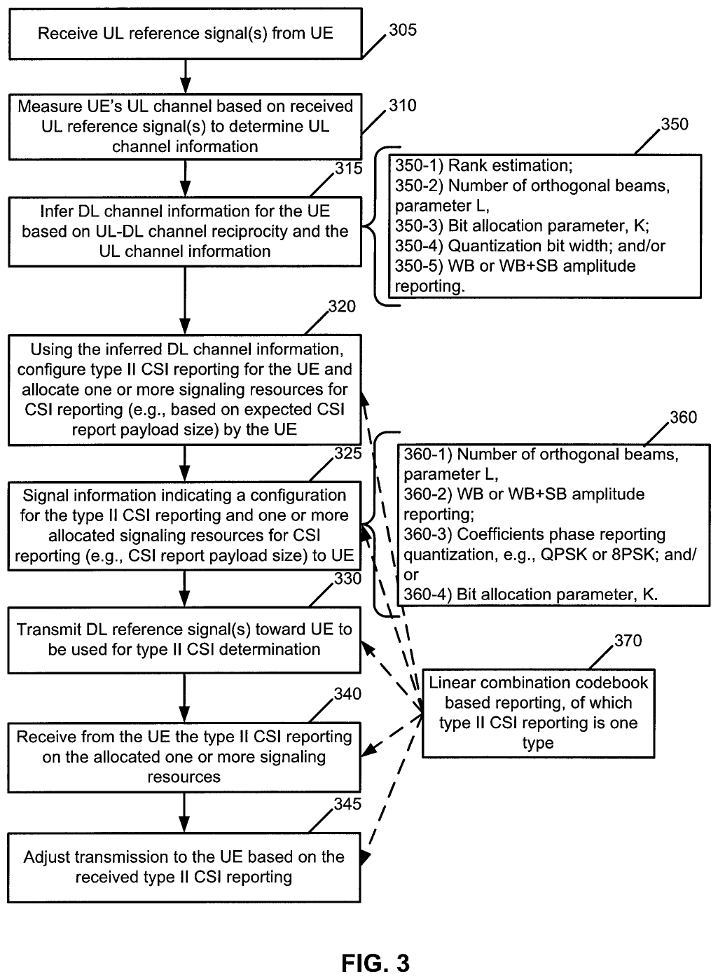

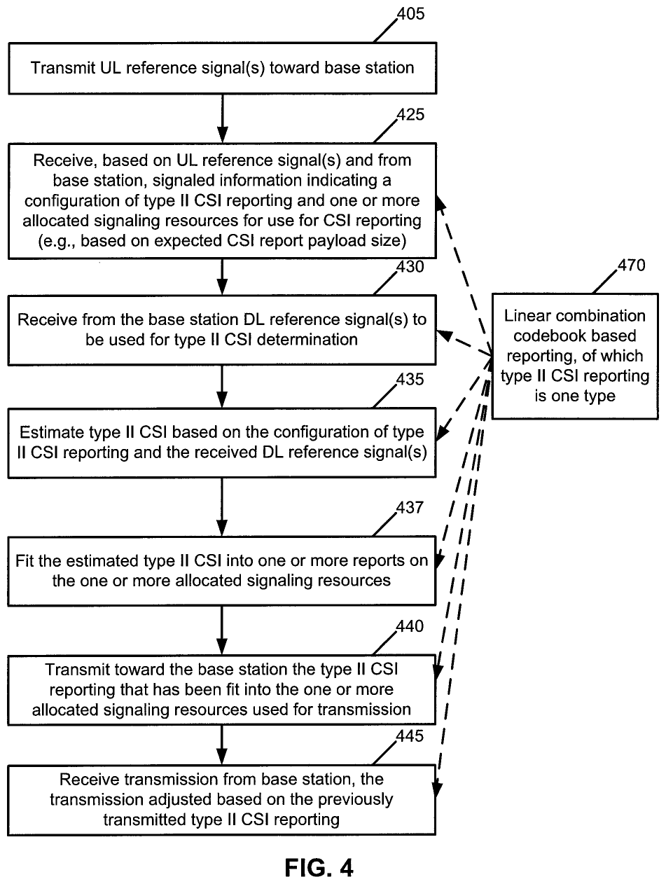

FIGS. 3 and 4 provide additional examples of possible flows that might be used in certain exemplary embodiments. Turning to FIG. 3, this figure is a logic flow diagram performed by a base station for reciprocity based CSI reporting configuration. This figure further illustrates the operation of an exemplary method or methods, a result of execution of computer program instructions embodied on a computer readable memory, functions performed by logic implemented in hardware, and/or interconnected means for performing functions in accordance with exemplary embodiments. For instance, the CSI module 150 may include multiples ones of the blocks in FIG. 3, where each included block is an interconnected means for performing the function in the block. The blocks in FIG. 3 are assumed to be performed by a base station such as gNB 170, e.g., under control of the CSI module 150 at least in part.

The gNB 170 in block 305 receives UL reference signal(s) from the UE 110, and in block 310 measures the UE's UL channel based on the received UL reference signal(s) to determine UL channel information. The gNB 170 infers, in block 315, DL channel information for the UE based on UL-DL channel reciprocity and the UL channel information. Multiple techniques have been described above for making this inference, and examples of these techniques are illustrated as inferred DL channel information 350. Such information may comprise one or more of the following: 350-1) Rank estimation (see section B(i) above); 350-2) Number of orthogonal beams, parameter L (see section B(ii) above); 350-3) Bit allocation parameter, K (see section B(iii) above); 350-4) Quantization bit width (see section B(iii) above); and/or 350-5) WB or WB+SB amplitude reporting (see section B(iii) above).

In block 320, the gNB 170, using the inferred DL channel information, configures type II CSI reporting for the UE and allocates one or more signaling resources for CSI reporting by the UE. The allocation of the one or more signaling resources may include CSI report payload size. Note that the gNB 170 can determine the CSI report payload size based on the inferences made in block 315. For instance, once some or all of the inferred DL channel information 350 is known by the gNB 170, a table (or other information) such as that shown in FIG. 2 may be used to determine the (e.g., inferred) total payload 210. This allows the gNB 170 to allocate resources for the type II CSI reporting.

The gNB 170 in block 325 signals information indicating a configuration for the type II CSI reporting and one or more allocated signaling resources for CSI reporting (e.g., CSI report payload size) to the UE 110. This configuration is dynamically signaled and the UE 110 should dynamically follow the new configuration and estimate and report CSI accordingly. As previously described and also illustrated in block 360, the configuration 360 may comprise one or more of the following configuration elements: 360-1) Number of orthogonal beams, parameter L; 360-2) WB or WB+SB amplitude reporting; 360-3) Coefficients phase reporting quantization, e.g., QPSK or 8PSK; and/or 360-4) Bit allocation parameter, K. This configuration 360 therefore allows the UE 110 to determine the total payload 210 (see FIG. 2) the UE 110 is to use for the type II CSI reporting, and the signaling in block 325 allows the UE 110 to know the allocated resource(s) into which this reporting should be fit.

It is noted that dynamically signaling the number of orthogonal beams, parameter L, in configuration element 360 provides multiple benefits. For example, sometimes the gNB is incapable to signal the right configuration, as UE channel changes while the configuration parameter is somehow fixed. As an example, gNB signals L=2 at the beginning of RRC configuration, then sometime later, the UE channel changes and L=4 is needed to better form the beam, but gNB cannot (in current situations) dynamically signal a new L to UE. Instead, the only way is through RRC reconfiguration, which usually takes a few hundred milliseconds. Further UE channel changes, adding/removing component cells, other gNB scheduling decisions, and the like all will impact the allocated resources, such that sometimes the gNB will actually deliberately allocate fewer resources because the gNB 170 has to do so. This is because from system overall point of view, the gNB 170 has to “sacrifice” some performance. All this sacrificing and incapability results from the mismatching/conflicting between the fixed configuration and dynamic resource allocation. These issues can be solved by, e.g., dynamically signaling of the parameter L as described herein. Once the parameter L can be dynamically signaled (e.g., we can have L=1, 2, 3, 4, for a case where two bits are used), the flexibility in dynamical signaling as well as the range of L will help solve this problem. By contract, the current fixed configuration follows a total different rationale, no UE channel information can be used during the RRC configuration, while using UE channel information to precisely predict the payload and then configure the codebook parameter is one part of the exemplary embodiments herein. Furthermore, omission might be totally removed if one simply configures L=4 for all cases and guarantee allocation of the maximum resources as possible. This, however, leads to an opposite direction, which is a huge waste of system resources. Dynamically signaling of the parameter L using prediction based on the UE channel and system scheduling is a way to avoid both insufficient allocation and waste. Rank and bit quantization are decided by the gNB, rank is dynamically signaled, and the cost is much less than RRC reconfiguration.

The gNB 170 transmits DL reference signal(s) toward the UE 110 to be used for type II CSI determination. This occurs in block 330. In block 340, the gNB 170 receives from the UE the type II CSI reporting on the allocated one or more signaling resources. The gNB 170 in block 345 adjusts transmission to the UE based on the received type II CSI report.

Primary emphasis in FIG. 3 is placed on type II CSI reporting. However, exemplary embodiments herein are applicable to other linear combination codebook based reporting, of which type II CSI reporting is one type. See block 370 of FIG. 3. That is, type II CSI reporting is one type of linear combination codebook based reporting, but the exemplary embodiments are not limited to type II CSI reporting.

Referring to FIG. 4, this figure is a logic flow diagram performed by a UE for reciprocity based CSI reporting configuration. This figure further illustrates the operation of an exemplary method or methods, a result of execution of computer program instructions embodied on a computer readable memory, functions performed by logic implemented in hardware, and/or interconnected means for performing functions in accordance with exemplary embodiments. For instance, the CSI module 140 may include multiples ones of the blocks in FIG. 4, where each included block is an interconnected means for performing the function in the block. The blocks in FIG. 4 are assumed to be performed by the UE 110, e.g., under control of the CSI module 140 at least in part.

The UE 110 in block 405 transmits UL reference signal(s) toward the base station. In block 425, the UE 110 receives, based on the UL reference signal(s) and from the base station, signaled information indicating a configuration of type II CSI reporting and one or more allocated signaling resources for use for CSI reporting (e.g., CSI report payload size). As previously described, this configuration (e.g., configuration 360) is dynamically signaled by the gNB 170 and the UE 110 should dynamically follow the new configuration and estimate and report CSI accordingly. In block 430, the UE 110 receives from the base station DL reference signal(s) to be used for type II CSI determination.

The UE 110 in block 435 estimates type II CSI based on the configuration (e.g., configuration 360) of type II CSI reporting and the received DL reference signal(s). The configuration 360 tells the UE what is to be reported and how, and the UE therefore decides the report payload (e.g., number of bits). In block 437, the UE 110 fits the estimated type II CSI into one or more reports on the one or more allocated signaling resources. The actual type II CSI reporting the UE 110 determines should be reported might be different from that inferred by the gNB 170. In other words, the one or more allocated signaling resources to be used by the UE 110 might be too small to fit the actual type II CSI reporting the UE 110 determines should be reported. In this case, the UE 110 makes a decision as to what type II CSI reporting information would be left out of the one or more allocated signaling resources. The decision is based on predefined omission rule(s) (as previously described) agreed upon between the gNB and UE. It should be noted that it is also possible the type II CSI reporting information that the UE 110 determines should be sent could occupy fewer resources than those allocated by the gNB 170. In this case, a number of options are possible, such as adding padding to the type II CSI reporting information.

In block 440, the UE 110 transmits toward the base station the type II CSI reporting that has been fit into the one or more allocated signaling resources used for transmission. In block 445, the UE 110 receives transmission from the base station, the transmission adjusted based on the previously transmitted type II CSI reporting.

As with FIG. 3, primary emphasis in FIG. 4 is placed on type II CSI reporting. However, exemplary embodiments herein are applicable to other linear combination codebook based reporting, of which type II CSI reporting is one type. See block 470 of FIG. 4. In other words, type II CSI reporting is one type of linear combination codebook based reporting, but the exemplary embodiments are not limited to type II CSI reporting.

Additional exemplary embodiments are as follows.

Example 1. A method, comprising:

measuring an uplink channel for a user equipment based on one or more reference signals from the user equipment, the measuring of the uplink channel determining uplink channel information;

inferring downlink channel information for the user equipment based on uplink-downlink channel reciprocity and the determined uplink channel information;

based on the inferred downlink channel information, configuring reporting for channel state information for the user equipment and allocating one or more resources for the user equipment to use to report the channel state information;

signaling to the user equipment information indicating a configuration of the reporting of channel state information and the one or more allocated resources;

transmitting one or more downlink reference signals toward the user equipment, the one or more downlink reference signals to be used by the user equipment for determination of the channel state information; and

receiving from the user equipment one or more reports of channel state information on the one or more allocated resources.

Example 2. The method of example 1, wherein the inferring downlink channel information further comprises inferring one or more of the following downlink channel information:

rank estimation;

number of orthogonal beams, parameter L;

bit allocation parameter, K, where a first K leading coefficients are to be reported with higher resolution;

quantization bit width; and

wideband amplitude reporting or wideband and subband amplitude reporting.

Example 3. The method of example 2, wherein inferring the rank estimation comprises:

computing a spatial channel covariance matrix at a current subframe n by averaging over all used physical resource blocks;

performing an Eigen decomposition of the spatial channel covariance matrix;

sorting Eigenvalues resulting from the Eigen decomposition into decreasing order; and

performing one of the following:

determining a rank as a maximum number of Eigenvalues greater than a threshold; or

measuring a difference between the first two highest ranked Eigenvalues and if the difference is greater than a threshold, the rank is one, otherwise the rank is two.

Example 4. The method of any of examples 2 or 3, wherein inferring the number of orthogonal beams, parameter L, comprises:

computing a spatial channel covariance matrix at a current subframe n by averaging over all used physical resource blocks;

performing an Eigen decomposition of the spatial channel covariance matrix;

computing correlation of a dominant Eigenvector from the Eigen decomposition with candidate orthogonal beams, comparing the correlation with a threshold, and counting a beam as a reported beam if the correlation for the beam is higher than the threshold, wherein the parameter L is set as the number of reported beams.

Example 5. The method of example 4, wherein, in response to the dominant Eigenvector correlating with several beams but the parameter L is set as the number of reported beams that is less than the several beams, the method further comprises enabling and setting codebook subset restriction to prevent less preferable orthogonal beams in the several beams but not in the number of reported beams from being reported.

Example 6. The method of example 4, wherein configuring reporting for channel state information for the user equipment further comprises using a beamformed channel state information codebook to configure reporting for the channel state information, and wherein parameter L is set as the number of reported beams and the beams are in accordance with the beamformed channel state information codebook.

Example 7. The method of any of examples 2 to 6, wherein inferring the wideband amplitude reporting or wideband and subband amplitude reporting comprises:

measuring channel frequency selectivity for a channel of the user equipment at least by performing the following:

computing a spatial channel covariance for each physical resource block of all used physical resource blocks;

taking an Eigen decomposition of the spatial channel covariance and acquiring a dominant Eigenvector for each physical resource block;

measuring an average correlation between a dominant Eigen vector for each physical resource block and a wideband dominant Eigen vector for all used physical resource blocks;

comparing the average correlation with a threshold, wherein an average correlation above the threshold indicates the channel for the user equipment is not frequency selective and an average correlation below the threshold indicates the channel for the user equipment is frequency selective;

using a result of the average correlation comparison to determine whether only wideband amplitude reporting or both wideband and subband amplitude reporting is to be used.

Example 8. The method of example 7, wherein inferring the quantization bit width further comprises using the result of the average correlation comparison as one element to adjust the quantization bit width.

Example 9. The method of example 8, wherein it is determined subband amplitude reporting is to be used and wherein inferring the quantization bit width further comprises determining whether more or fewer bits should be used for the subband amplitude reporting.

Example 10. The method of any of examples 7 to 9, wherein inferring the bit allocation parameter, K, further comprises:

adjusting the parameter K to adjust overhead by allowing more bits for those beams associated with higher-valued Eigen vectors and fewer bits for beams associated with lower-valued Eigen vectors.

Example 11. A method, comprising:

transmitting one or more reference signals toward a base station;

receiving, based in part on the transmitted one or more reference signals and from the base station, signaling indicating a configuration of reporting of channel state information to be used by the user equipment and one or more allocated resources to be used for the reporting;

receiving one or more downlink reference signals from the base station;

determining the channel state information using the configuration of reporting of channel state information and the received one or more downlink reference signals;

fitting the determined channel state information into the one or more allocated resources; and

transmitting toward the base station one or more reports of the channel state information on the one or more allocated resources.

Example 12. The method of example 11, wherein fitting further comprises fitting the determined channel state information into the one or more allocated resources by omitting at least some of the determined channel state information according to one or more rules previously agreed upon between the user equipment and the base station.

Example 13. The method of any of the above method examples, wherein the configuration comprises one or more of the following:

a number of orthogonal beams, parameter L;

wideband amplitude reporting or wideband and subband amplitude reporting;

coefficients phase reporting quantization; and

a bit allocation parameter, K, where a first K leading coefficients are to be reported with higher resolution.

Example 14. The method of any of the above method examples, wherein the configuration of reporting for the channel state information is a configuration in accordance with linear combination codebook based reporting.

Example 15. The method of any of the above method examples, applied to a frequency division duplex system.

Example 16. The method of any of the above method examples, wherein only a partial uplink channel from the user equipment to the base station is available.

Example 17. An apparatus comprising means for performing:

measuring an uplink channel for a user equipment based on one or more reference signals from the user equipment, the measuring of the uplink channel determining uplink channel information;

inferring downlink channel information for the user equipment based on uplink-downlink channel reciprocity and the determined uplink channel information;

based on the inferred downlink channel information, configuring reporting for channel state information for the user equipment and allocating one or more resources for the user equipment to use to report the channel state information;

signaling to the user equipment information indicating a configuration of the reporting of channel state information and the one or more allocated resources;

transmitting one or more downlink reference signals toward the user equipment, the one or more downlink reference signals to be used by the user equipment for determination of the channel state information; and

receiving from the user equipment one or more reports of channel state information on the one or more allocated resources.

Example 18. The apparatus of example 17, wherein the inferring downlink channel information further comprises inferring one or more of the following downlink channel information:

rank estimation;

number of orthogonal beams, parameter L;

bit allocation parameter, K, where a first K leading coefficients are to be reported with higher resolution;

quantization bit width; and

wideband amplitude reporting or wideband and subband amplitude reporting.

Example 19. The apparatus of example 18, wherein inferring the rank estimation comprises:

computing a spatial channel covariance matrix at a current subframe n by averaging over all used physical resource blocks;

performing an Eigen decomposition of the spatial channel covariance matrix;

sorting Eigenvalues resulting from the Eigen decomposition into decreasing order; and

performing one of the following:

determining a rank as a maximum number of Eigenvalues greater than a threshold; or

measuring a difference between the first two highest ranked Eigenvalues and if the difference is greater than a threshold, the rank is one, otherwise the rank is two.

Example 20. The apparatus of any of examples 18 or 19, wherein inferring the number of orthogonal beams, parameter L, comprises:

computing a spatial channel covariance matrix at a current subframe n by averaging over all used physical resource blocks;

performing an Eigen decomposition of the spatial channel covariance matrix;

computing correlation of a dominant Eigenvector from the Eigen decomposition with candidate orthogonal beams, comparing the correlation with a threshold, and counting a beam as a reported beam if the correlation for the beam is higher than the threshold, wherein the parameter L is set as the number of reported beams.

Example 21. The apparatus of example 20, wherein, in response to the dominant Eigenvector correlating with several beams but the parameter L is set as the number of reported beams that is less than the several beams, and wherein the means are further configured to perform enabling and setting codebook subset restriction to prevent less preferable orthogonal beams in the several beams but not in the number of reported beams from being reported.

Example 22. The apparatus of example 20, wherein configuring reporting for channel state information for the user equipment further comprises using a beamformed channel state information codebook to configure reporting for the channel state information, and wherein parameter L is set as the number of reported beams and the beams are in accordance with the beamformed channel state information codebook.

Example 23. The apparatus of any of examples 18 to 22, wherein inferring the wideband amplitude reporting or wideband and subband amplitude reporting comprises:

measuring channel frequency selectivity for a channel of the user equipment at least by performing the following:

computing a spatial channel covariance for each physical resource block of all used physical resource blocks;

taking an Eigen decomposition of the spatial channel covariance and acquiring a dominant Eigenvector for each physical resource block;

measuring an average correlation between a dominant Eigen vector for each physical resource block and a wideband dominant Eigen vector for all used physical resource blocks;

comparing the average correlation with a threshold, wherein an average correlation above the threshold indicates the channel for the user equipment is not frequency selective and an average correlation below the threshold indicates the channel for the user equipment is frequency selective;

using a result of the average correlation comparison to determine whether only wideband amplitude reporting or both wideband and subband amplitude reporting is to be used.

Example 24. The apparatus of example 23, wherein inferring the quantization bit width further comprises using the result of the average correlation comparison as one element to adjust the quantization bit width.

Example 25. The apparatus of example 24, wherein it is determined subband amplitude reporting is to be used and wherein inferring the quantization bit width further comprises determining whether more or fewer bits should be used for the subband amplitude reporting.

Example 26. The apparatus of any of examples 23 to 25, wherein inferring the bit allocation parameter, K, further comprises:

adjusting the parameter K to adjust overhead by allowing more bits for those beams associated with higher-valued Eigen vectors and fewer bits for beams associated with lower-valued Eigen vectors.

Example 27. An apparatus comprising means for performing:

transmitting one or more reference signals toward a base station;

receiving, based in part on the transmitted one or more reference signals and from the base station, signaling indicating a configuration of reporting of channel state information to be used by the user equipment and one or more allocated resources to be used for the reporting;

receiving one or more downlink reference signals from the base station;

determining the channel state information using the configuration of reporting of channel state information and the received one or more downlink reference signals;

fitting the determined channel state information into the one or more allocated resources; and

transmitting toward the base station one or more reports of the channel state information on the one or more allocated resources.

Example 28. The apparatus of example 12, wherein fitting further comprises fitting the determined channel state information into the one or more allocated resources by omitting at least some of the determined channel state information according to one or more rules previously agreed upon between the user equipment and the base station.

Example 29. The apparatus of any of the above apparatus examples, wherein the configuration comprises one or more of the following:

a number of orthogonal beams, parameter L;

wideband amplitude reporting or wideband and subband amplitude reporting;

coefficients phase reporting quantization; and

a bit allocation parameter, K, where a first K leading coefficients are to be reported with higher resolution.

Example 30. The apparatus of any of the above apparatus examples, wherein the configuration of reporting for the channel state information is a configuration in accordance with linear combination codebook based reporting.

Example 31. The apparatus of any of the above apparatus examples, applied to a frequency division duplex system.

Example 32. The apparatus of any of the above apparatus examples, wherein only a partial uplink channel from the user equipment to the base station is available.

Example 33. The apparatus of any preceding apparatus example wherein the means comprises:

at least one processor; and

at least one memory including computer program code, the at least one memory and computer program code configured to, with the at least one processor, cause the performance of the apparatus.

Example 34. A base station comprising any of the apparatus of examples 17 to 26 or 29 to 33.

Example 35. A user equipment comprising any of the apparatus of examples 27 to 33.

Example 36. A wireless communications system comprising an apparatus according to example 34 and an apparatus according to example 35.

Example 37. A computer program, comprising code for performing the method in any of examples 1 to 16, when the computer program is run on a processor.

Example 38. The computer program according to example 37, wherein the computer program is a computer program product comprising a computer-readable medium bearing computer program code embodied therein for use with a computer.

Example 39. An apparatus, comprising:

one or more processors; and

one or more memories including computer program code,

the one or more memories and the computer program code configured, with the one or more processors, to cause the apparatus to perform at least the following:

measuring an uplink channel for a user equipment based on one or more reference signals from the user equipment, the measuring of the uplink channel determining uplink channel information;

inferring downlink channel information for the user equipment based on uplink-downlink channel reciprocity and the determined uplink channel information;

based on the inferred downlink channel information, configuring reporting for channel state information for the user equipment and allocating one or more resources for the user equipment to use to report the channel state information;

signaling to the user equipment information indicating a configuration of the reporting of channel state information and the one or more allocated resources;

transmitting one or more downlink reference signals toward the user equipment, the one or more downlink reference signals to be used by the user equipment for determination of the channel state information; and

receiving from the user equipment one or more reports of channel state information on the one or more allocated resources.

Example 40. The apparatus of example 39, wherein the one or more memories and the computer program code are configured, with the one or more processors, to cause the apparatus to perform the method according to any of examples 1 to 10 or 13 to 16.

Example 41. An apparatus, comprising:

one or more processors; and

one or more memories including computer program code,

the one or more memories and the computer program code configured, with the one or more processors, to cause the apparatus to perform at least the following:

transmitting one or more reference signals toward a base station;

receiving, based in part on the transmitted one or more reference signals and from the base station, signaling indicating a configuration of reporting of channel state information to be used by the user equipment and one or more allocated resources to be used for the reporting;

receiving one or more downlink reference signals from the base station;

determining the channel state information using the configuration of reporting of channel state information and the received one or more downlink reference signals;

fitting the determined channel state information into the one or more allocated resources; and

transmitting toward the base station one or more reports of the channel state information on the one or more allocated resources.

Example 42. The apparatus of example 41, wherein the one or more memories and the computer program code are configured, with the one or more processors, to cause the apparatus to perform the method according to any of examples 11 to 16.

Without in any way limiting the scope, interpretation, or application of the claims appearing below, a technical effect of one or more of the example embodiments disclosed herein is prediction and allocation of the signaling resource(s) for type II CSI reporting by exploring channel reciprocity between UL and DL in NR MIMO system. Another technical effect of one or more of the example embodiments disclosed herein is avoidance of partial omission of CSI report or a waste of signaling resource. Another technical effect of one or more of the example embodiments disclosed herein is improvement in signaling overhead efficiency while type II CSI reporting performance is guaranteed.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
2D two dimensional
2G, 3G, 4G, 5G second, third, fourth, and fifth generation (G)
CBSR codebook subset restriction
CSI channel state information
DCI downlink control information
DFT discrete Fourier transform
DL downlink (from base station to UE)
eNB (or eNodeB) evolved Node B (e.g., an LTE base station)
FDD frequency division duplex
FFS for future study
gNB 170 base station for 5G/NR
HW hardware
I/F interface
IoT Internet of things
LCC linear combination codebook
LTE long term evolution
MAC medium access control
MAC-CE MAC control element
MIMO multiple input, multiple output
MME mobility management entity
MRC max ratio combining
NCE network control element
NLoS non-line of sight
NR new radio
N/W network
PMI precoding matrix indicator
PRB physical resource block
R15 release 15
RAN radio access network
RRC radio resource control
RRH remote radio head
Rx receiver
SB subband
SGW serving gateway
SRS sounding reference signals
TDD time division duplex
Tx transmitter
UE user equipment (e.g., a wireless, typically mobile device)
UL uplink (from UE to base station)
WB wideband

1-42. (canceled)

43. A method, comprising:
measuring an uplink channel for a user equipment based on one or more reference signals from the user equipment, the measuring of the uplink channel determining uplink channel information;
inferring downlink channel information for the user equipment based on uplink-downlink channel reciprocity and the determined uplink channel information;
based on the inferred downlink channel information, configuring reporting for channel state information for the user equipment and allocating one or more resources for the user equipment to use to report the channel state information;
signaling to the user equipment information indicating a configuration of the reporting of channel state information and the one or more allocated resources;
transmitting one or more downlink reference signals toward the user equipment, the one or more downlink reference signals to be used by the user equipment for determination of the channel state information; and
receiving from the user equipment one or more reports of channel state information on the one or more allocated resources.

44. The method of claim 43, wherein the inferring downlink channel information further comprises inferring one or more of the following downlink channel information:
rank estimation;
number of orthogonal beams, parameter L;
bit allocation parameter, K, where a first K leading coefficients are to be reported with higher resolution;
quantization bit width; and
wideband amplitude reporting or wideband and subband amplitude reporting.

45. The method of claim 44, wherein inferring the rank estimation comprises:
computing a spatial channel covariance matrix at a current subframe n by averaging over all used physical resource blocks;
performing an Eigen decomposition of the spatial channel covariance matrix;
sorting Eigenvalues resulting from the Eigen decomposition into decreasing order; and
performing one of the following:
determining a rank as a maximum number of Eigenvalues greater than a threshold; or
measuring a difference between the first two highest ranked Eigenvalues and if the difference is greater than a threshold, the rank is one, otherwise the rank is two.

46. The method of any of claim 44, wherein inferring the number of orthogonal beams, parameter L, comprises:
computing a spatial channel covariance matrix at a current subframe n by averaging over all used physical resource blocks;
performing an Eigen decomposition of the spatial channel covariance matrix;
computing correlation of a dominant Eigenvector from the Eigen decomposition with candidate orthogonal beams, comparing the correlation with a threshold, and counting a beam as a reported beam if the correlation for the beam is higher than the threshold, wherein the parameter L is set as the number of reported beams.

47. The method of claim 46, wherein, in response to the dominant Eigenvector correlating with several beams but the parameter L is set as the number of reported beams that is less than the several beams, the method further comprises enabling and setting codebook subset restriction to prevent less preferable orthogonal beams in the several beams but not in the number of reported beams from being reported.

48. The method of claim 46, wherein configuring reporting for channel state information for the user equipment further comprises using a beamformed channel state information codebook to configure reporting for the channel state information, and wherein parameter L is set as the number of reported beams and the beams are in accordance with the beamformed channel state information codebook.

49. The method of any of claim 44, wherein inferring the wideband amplitude reporting or wideband and subband amplitude reporting comprises:
measuring channel frequency selectivity for a channel of the user equipment at least by performing the following:
computing a spatial channel covariance for each physical resource block of all used physical resource blocks;
taking an Eigen decomposition of the spatial channel covariance and acquiring a dominant Eigenvector for each physical resource block;
measuring an average correlation between a dominant Eigen vector for each physical resource block and a wideband dominant Eigen vector for all used physical resource blocks;
comparing the average correlation with a threshold, wherein an average correlation above the threshold indicates the channel for the user equipment is not frequency selective and an average correlation below the threshold indicates the channel for the user equipment is frequency selective;
using a result of the average correlation comparison to determine whether only wideband amplitude reporting or both wideband and subband amplitude reporting is to be used.

50. The method of claim 49, wherein inferring the quantization bit width further comprises using the result of the average correlation comparison as one element to adjust the quantization bit width.

51. The method of claim 50, wherein it is determined subband amplitude reporting is to be used and wherein inferring the quantization bit width further comprises determining whether more or fewer bits should be used for the subband amplitude reporting.

52. The method of any of claim 49, wherein inferring the bit allocation parameter, K, further comprises:
adjusting the parameter K to adjust overhead by allowing more bits for those beams associated with higher-valued Eigen vectors and fewer bits for beams associated with lower-valued Eigen vectors.

53. A method, comprising:
transmitting one or more reference signals toward a base station;
receiving, based in part on the transmitted one or more reference signals and from the base station, signaling indicating a configuration of reporting of channel state information to be used by the user equipment and one or more allocated resources to be used for the reporting;
receiving one or more downlink reference signals from the base station;
determining the channel state information using the configuration of reporting of channel state information and the received one or more downlink reference signals;
fitting the determined channel state information into the one or more allocated resources; and
transmitting toward the base station one or more reports of the channel state information on the one or more allocated resources.

54. The method of claim 53, wherein fitting further comprises fitting the determined channel state information into the one or more allocated resources by omitting at least some of the determined channel state information according to one or more rules previously agreed upon between the user equipment and the base station.

55. The method of claim 53, wherein the configuration comprises one or more of the following:
a number of orthogonal beams, parameter L;
wideband amplitude reporting or wideband and subband amplitude reporting;
coefficients phase reporting quantization; and
a bit allocation parameter, K, where a first K leading coefficients are to be reported with higher resolution.

56. The method of claim 53, wherein the configuration of reporting for the channel state information is a configuration in accordance with linear combination codebook based reporting.

57. A computer program product comprising a non-transitory computer-readable storage medium bearing computer code embodied therein for use with a computer, the computer program code comprising code for performing the method of 43.

58. A computer program product comprising a non-transitory computer-readable storage medium bearing computer code embodied therein for use with a computer, the computer program code comprising code for performing the method of 53.

59. An apparatus, comprising:
one or more processors; and
one or more memories including computer program code,
the one or more memories and the computer program code configured, with the one or more processors, to cause the apparatus to perform at least the following:
measuring an uplink channel for a user equipment based on one or more reference signals from the user equipment, the measuring of the uplink channel determining uplink channel information;
inferring downlink channel information for the user equipment based on uplink-downlink channel reciprocity and the determined uplink channel information;
based on the inferred downlink channel information, configuring reporting for channel state information for the user equipment and allocating one or more resources for the user equipment to use to report the channel state information;
signaling to the user equipment information indicating a configuration of the reporting of channel state information and the one or more allocated resources;
transmitting one or more downlink reference signals toward the user equipment, the one or more downlink reference signals to be used by the user equipment for determination of the channel state information; and
receiving from the user equipment one or more reports of channel state information on the one or more allocated resources.

60. An apparatus, comprising:
one or more processors; and
one or more memories including computer program code,
the one or more memories and the computer program code configured, with the one or more processors, to cause the apparatus to perform at least the following:
transmitting one or more reference signals toward a base station;
receiving, based in part on the transmitted one or more reference signals and from the base station, signaling indicating a configuration of reporting of channel state information to be used by the user equipment and one or more allocated resources to be used for the reporting;
receiving one or more downlink reference signals from the base station;
determining the channel state information using the configuration of reporting of channel state information and the received one or more downlink reference signals;
fitting the determined channel state information into the one or more allocated resources; and
transmitting toward the base station one or more reports of the channel state information on the one or more allocated resources.
